(19) United States
(12) Patent Application Publication
(10) Pub. No.: US 2012/0203618 A1
(43) Pub. Date: Aug. 9, 2012

(54) IMAGE PRINTING SYSTEMS AND METHODS

(75) Inventor: Stefan Roever, Atherton, CA (US)

(73) Assignee: UPWAVE, INC., San Jose, CA (US)

(21) Appl. No.: 13/022,472

(22) Filed: Feb. 7, 2011

(51) Int. Cl. G06Q 30/00

(52) U.S. Cl. 705/14.35; 705/14.39

(57) ABSTRACT

An advertising-financed print service is enabled in which the printing of content by consumers is subsidized, in whole or in part, by the presentation of commercial content (e.g., coupons and offers) to the consumers.

### BACKGROUND OF THE INVENTION

The present invention relates to methods and apparatus for printing images and, in some embodiments, printing commercial content such as offers and coupons.

Commercial entities such as advertisers and merchants devote significant resources to developing and executing marketing campaigns to improve sales of the products and services. Such campaigns may involve the use and distribution of conventional print media (e.g., newspapers, magazines, commercial mailings, etc.), and increasingly a wide variety of electronic media (e.g., online advertising, coupon sites, email marketing, etc.). But despite the ubiquity and increasing sophistication of online marketing tools and techniques, the effectiveness of these approaches, as represented by actual economic conversion events (e.g., a consumer redeeming a coupon), still has considerable room for improvement. Both consumers and commercial entities would benefit from techniques by which more targeted and relevant commercial opportunities are made available to consumers.

### SUMMARY OF THE INVENTION

According to specific embodiments of the present invention, methods and apparatus are provided for operating a printing appliance connected to a network. A first connection is established to a computing device operating on the network. A second connection is established to the printing appliance over the network. In response to identification of elective content by the computing device via the first connection, the elective content is transmitted to the printing appliance via the second connection. Printing of the elective content by the printing appliance is controlled via the second connection without intervention by the computing device. Commercial content is selected without intervention by the computing device. The commercial content is transmitted to the printing appliance via the second connection. Printing of the commercial content by the printing appliance is controlled via the second connection without intervention by the computing device

According to specific embodiments, methods and apparatus are provided for using a printing appliance on a network. A first connection is established between a computing device operating on the network and a remote portal service over the network. A second connection is established between the printing appliance and the remote portal service over the network. Elective content is identified to the remote portal service via the first connection. The elective content is received at the printing appliance via the second connection. The elective content are printed with the printing appliance under control of the remote portal service via the second connection without intervention by the computing device. Commercial content is received at the printing appliance via the second connection without intervention by the computing device. The commercial content is printed with the printing appliance under control of the remote portal service via the second connection without intervention by the computing device.

According to specific embodiments, methods and apparatus are provided for operating a printing appliance connected to a network. A first connection is established over the network to a third-party web site to which a computing device operating on the network is also connected. A second connection is established to the printing appliance over the network. Elective content is received via the first connection in response to identification of the elective content on the third-party web site by the computing device. The elective content is transmitted to the printing appliance via the second connection. Printing of the elective content by the printing appliance is controlled via the second connection without intervention by the computing device. Commercial content is selected without intervention by the computing device. The commercial content is transmitted to the printing appliance via the second connection. Printing of the commercial content by the printing appliance is controlled via the second connection without intervention by the computing device.

According to specific embodiments, methods and apparatus are provided for using a printing appliance on a network. A first connection is authorized over the network between a remote portal service and a third-party web site to which a computing device operating on the network is also connected. A second connection is established between the printing appliance and the remote portal service over the network. Elective content on the third-party web site is identified for transmission to the remote portal service via the first connection. The elective content is received at the printing appliance via the second connection. The elective content is printed with the printing appliance under control of the remote portal service via the second connection without intervention by the computing device. Commercial content is received at the printing appliance via the second connection without intervention by the computing device. The commercial content is printed with the printing appliance under control of the remote portal service via the second connection without intervention by the computing device.

According to specific embodiments, methods and apparatus are provided for supporting a printing appliance connected to a network. A first connection is established to the printing appliance over the network. Printing by the printing appliance of commercial content is tracked via the first connection. Where one or more criteria relating to the printed commercial content is met, print consumables are sent to an address associated with the printing appliance. The print consumables are required for operation of the printing appliance, and are economically subsidized in relation to meeting of the one or more criteria.

According to specific embodiment, a printing appliance is provided for use on a network. The printing appliance includes a printing subsystem configured to print content on a print medium. A configuration interface is configured to facilitate connection of the printing appliance to the network. Processing resources are configured to control operation of the printing appliance. A network interface is configured to connect to the network and to enable communication between the processing resources and a remote portal service via a connection over the network. The processing resources are further configured to only allow printing of the content by the printing subsystem under control of the remote portal service via the connection.

According to specific embodiments, methods and apparatus are provided for managing commercial offers. An interface is provided in a computing device by which a user may gain restricted access to the commercial offers. The restricted access limits the user to taking advantage of only a specified number of the commercial offers during each of a plurality of consecutive time periods. In the interface the user is enabled to prioritize a first subset of the commercial offers for a first number of the consecutive time periods, thereby reordering the first subset of the commercial offers relative to the first number of the consecutive time periods. The user is enabled to take advantage of the specified number of the first subset of commercial offers during each of the first number of consecutive time periods in accordance with the reordering of the first subset of the commercial offers.

A further understanding of the nature and advantages of the present invention may be realized by reference to the remaining portions of the specification and the drawings.

### BRIEF DESCRIPTION OF THE DRAWINGS

FIG. 1 is a simplified diagram of a computing environment in which various embodiments of the invention may be implemented.

FIG. 2 is a flowchart illustrating printing of content in accordance with a specific embodiment of the invention.

FIG. 3 is a simplified block diagram of a printing appliance for use with specific embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to some embodiments of the invention, an advertising-financed print service is enabled in which the printing of content by consumers is subsidized, in whole or in part, by the presentation of commercial content to the consumers. As used herein, the term “commercial content” refers to any type of content which conveys information relating to a commercial, marketing, or economic opportunity of which one or more consumers may take advantage. Commercial content may therefore include, for example, offers, advertisements, coupons, marketing materials, etc. In the examples described below, it should be understood that, while reference may be made to a particular type of commercial content, e.g., coupons or offers, this is done merely for illustrative purposes, and that embodiments of the invention are more generally applicable to any type of commercial content. The invention should therefore not be limited by such references.

According to a particular class of embodiments, each consumer (also referred to herein as a user) is provided a printing appliance and the print consumables required to use the printing appliance. These may be provided without charge, or at a reduced or subsidized rate. Such print consumables may include, for example, toner, ink cartridges, paper (conventional or specialized), etc. The printing appliance and print consumables and an ongoing subsidy of the print consumables are provided in exchange for the printing of the commercial content with the printing appliance and/or economic conversion events associated with the commercial content, e.g., purchase of a product or service that is the subject of an offer, redemption of a coupon, etc.

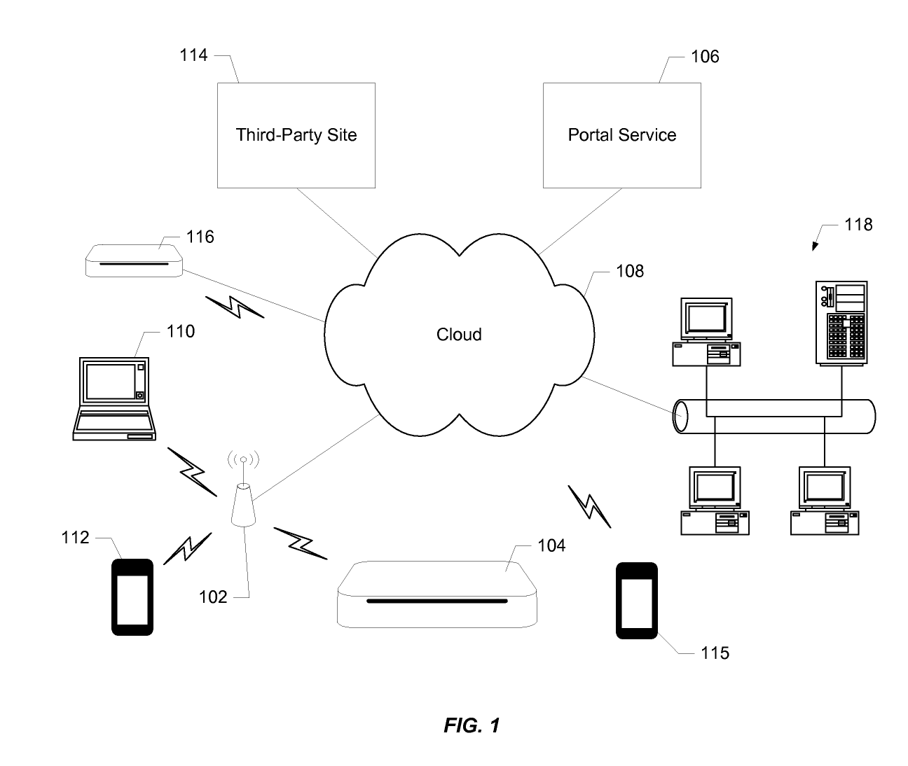

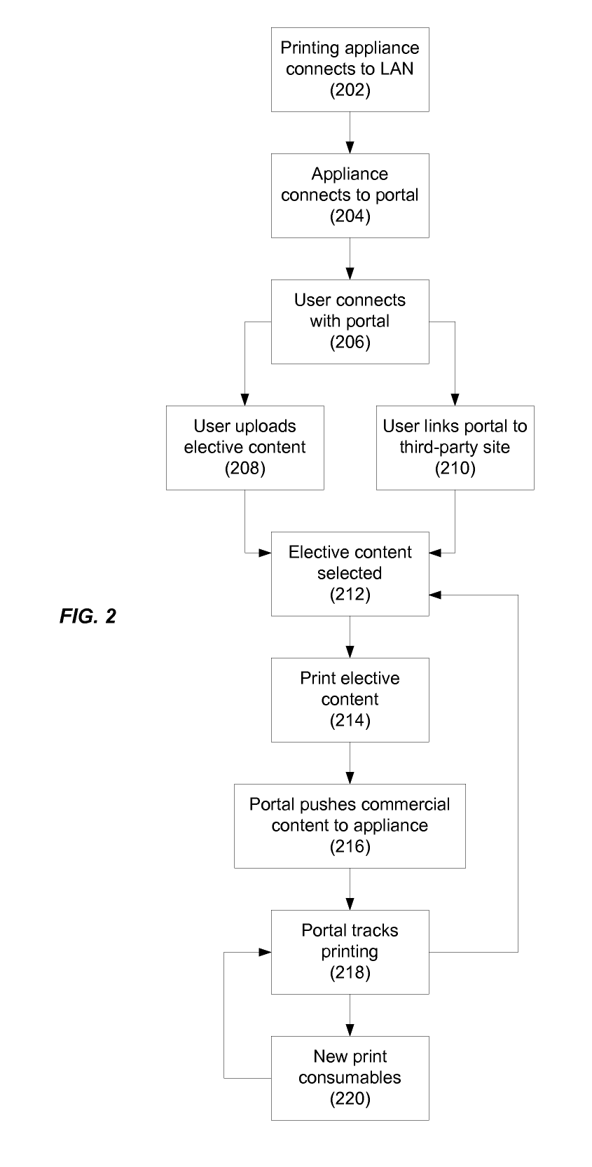

According to more specific embodiments, and referring to FIGS. 1 and 2, once connected to the user's local area network (represented by wireless access point 102) (202), the printing appliance 104 is configured to connect and register (204) with a printing service 106 (also referred to herein as a “portal” or “portal service”) operating in the cloud 108. It should be understood that the details of the user's local area network may vary widely and employ both wired and wireless communications without departing from the scope of the invention.

And as used herein, the term “cloud” refers to any of a wide variety of distributed computing environments in which the processes and/or functionalities described herein may be implemented. The term “cloud” refers generally to the fact that the processes and functionalities are generally agnostic to the distribution and configuration of the underlying hardware processing resources. Embodiments of the invention are contemplated in which the described portal service is hosted on one or more servers which may be remotely accessed by users, and/or connected with third-party sites over the Internet using the Internet Protocol and related technologies. However, it will be understood by those of ordinary skill in the art that use of the term “cloud” implies a much wider variety of distributed computing environments that may be suitable for various implementations. As such, the present invention should not be limited by reference herein to particular computing environments, conventions, or paradigms.

Once the user's printing appliance is connected to the portal service, the user connects with the portal service (206) via a separate IP connection to print content selected by the user, also referred to herein as “elective content” or “elective prints.” It is contemplated that such elective prints might include, but are not limited to, photographs. User selection of elective content may be achieved, for example, by the user uploading the elective content to the portal service (208), e.g., from the user's home computer 110 (e.g., a laptop, desktop, notebook, Internet-enabled television, etc.) or mobile device 112 (e.g., cell phone, personal digital assistant, smart phone, tablet, etc.), or by linking his portal account to a third-party site 114 (210) on which elective content may be stored (e.g., Facebook or Flickr), and then selecting (either on the portal service or the connected site) which elective content the user would like to print on his local printing appliance (212). Connection to third-party sites may be enabled by the user providing permission to the portal service to make such a connection (e.g., by providing his account user name and password). Regardless of the source of the elective content, the portal service obtains the elective content selected, pushes it to the printing appliance, and controls printing of the elective content on the printing appliance (214).

According to a particular implementation, the printing of content (commercial or elective) by each user's local printing appliance is exclusively controlled by the portal service in the cloud. That is, all content to be printed by the printing appliance is either received directly from or under the direction of the portal service. Such back end control of the printing of content on the printing appliance has a number of advantages relative to more conventional approaches in which the user has control of his local printer. For example, to enable the efficient and secure distribution of commercial content while allowing local control of the printer typically requires deployment, management, and support of sophisticated layers of authentication and security on each user's local area network. As will become clear, exclusive back end control of content printing obviates such requirements.

The user may identify the elective content to be printed by the portal service via his account interface using, for example, a standard web browser. The portal service may be configured to track a variety of information for each printing appliance including, for example, printer status, what is being printed, how many pages of content were printed, etc. The back end control of the printing appliance by the portal service enables the pushing or insertion of commercial content (216) which may, according to some embodiments, be specifically targeted to the user's demographic, geographic location, and/or printing habits. It also allows the portal service to determine when new print consumables should be sent to the user. It should be understood that, despite the apparent order of operations shown in the flowchart of FIG. 2, the timing of elective and commercial prints need not be consecutive and are not required to be synchronized in any particular way. That is, embodiments of the invention contemplate a wide variety of relationships between the amount and timing of each type of print that are within the scope of the invention. Indeed, as will be discussed, embodiments of the invention are contemplated in which these the relative number of elective and commercial prints and/or the timing of each may be manipulated to realize further advantages.

According to various implementations, the pushing of commercial content to the printing appliance can be automatic, e.g., inserted every 5^{th} page, each morning, or each time the printing appliance is powered up. In some embodiments, the printing appliance may even be “woken up” from a low-power or off state for the printing of commercial content. Alternatively, the user may in some cases be given a choice as to whether and when commercial content may be printed. For example, the user may receive a text or an email indicating the nature of a commercial offer or coupon that is available, in response to which the user may opt to have the commercial content sent to his printing appliance. Certain classes of commercial content may also be made available by the portal service that the user can electively select and print.

As mentioned above, the portal service can track the print quantity (218) so that new print consumables can be sent to the user at the appropriate time (220). Users that don't meet the criteria for additional print consumables (e.g., users that don't redeem a sufficient number of coupons) can be required to pay for additional print consumables. Additionally, the degree to which print consumables are subsidized may vary with user engagement with the portal service.

According to a particular class of embodiments, the portal service employs elective print “credits” to determine whether a user is allowed to print elective content, e.g., regardless of the user's supply of print consumables, the printing of elective content would only be allowed if the user has elective print credits. According to various ones of these embodiments, the user can accumulate elective print credits in a variety of ways. For example, elective print credits might be awarded in relation to the number of commercial content prints that have occurred. In another example, elective print credits could be awarded if the user leaves his printing appliance on so that commercial content may be printed at any time. More generally, user engagement with the portal service, including users taking advantage of commercial opportunities made available by the portal service, may be used as a basis for awarding elective print credits. And in some of these implementations, the portal service may then provide print consumables in sufficient quantity to ensure that the user has enough of a supply to cover his elective content credits and the desired commercial print quantity.

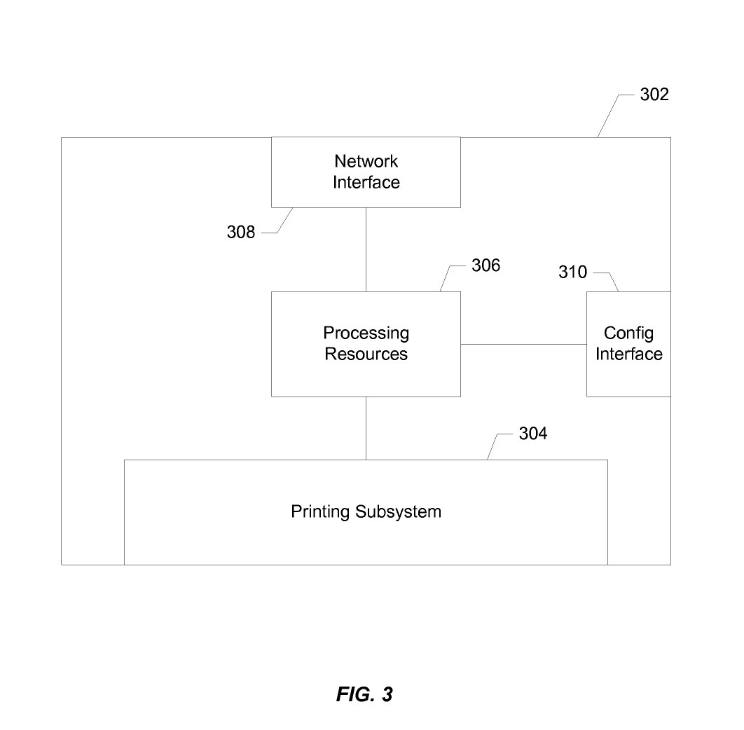

A specific implementation of a printing appliance for use with specific embodiments of the invention is shown in FIG. 3. The printing appliance 302 includes a printing subsystem 304, processing resources 306 (e.g., one or more microprocessors and associated memory) configured to control operation of the appliance, a network interface 308 (e.g., wireless and/or Ethernet, 3G or 4G mobile data, telecommunications, cable, satellite, etc.), and a configuration interface 310 for facilitating the initial setup of the printing appliance on the user's local network.

Configuration interface 310 may be a physical interface integrated with the appliance with which the user can interact directly (e.g., keypad, touch screen, etc.). Alternatively, the configuration interface could be implemented with an application programming interface (API) with which an external device (e.g., a smart phone) connects (e.g., using a wifi or Bluetooth). According to yet another alternative, configuration of the printing appliance may be achieved using a web (e.g., HTML) interface which becomes accessible once the printing appliance is plugged in to the user's local area network. Once the printing appliance is configured via the web interface, the printing appliance can be unplugged if configured to operate on the user's wifi network. In any case, the user employs the configuration interface to set up the printing appliance on his local area network, with control of the printing appliance then being handled by the portal service once the appliance connects to and registers with the portal service (e.g., via its network interface over the Internet).

It should be understood that printing appliances enabled by various embodiments of the present invention need not necessarily be operating on the same network as the device with which the user is engaging with the portal service (or third-party site) and/or identifying elective content for printing. For example, the printing appliance may be connected to the user's home network while the user is engaging with the portal service or browsing his Facebook content via a mobile data network (e.g., 3G, 4G, etc.) nearby, or in an entirely different geographic location (e.g., see mobile device 115 in FIG. 1). Alternatively or in addition, the printing appliance itself may operate as a mobile appliance, connecting to the cloud via, for example, a wireless hot spot or a mobile data network, (e.g., using a subscriber identification module (SIM) card and related technologies) so that the user can initiate printing from any location (e.g., printing appliance 116). Such an approach could allow the portal service to push commercial content based on the appliance's current location (e.g., as determined by GPS, cell location, IP address, etc.). So, for example, if a user printing appliance is in proximity to a Starbuck's wifi hot spot, a coupon for a latte could be pushed to the user's appliance. Those of skill in the art will appreciate the myriad ways in which both the printing appliance and the user may connect and/or engage with the portal service without departing from the scope of the invention.

Printing subsystem 304 may be implemented using any of a wide variety of conventional and proprietary printing technologies including, for example, inkjet, laser, and thermal printing technologies. According to specific embodiments, the printing appliance is implemented with an inkless printing technology developed by Polaroid, Inc. of Minnetonka, Minn., and currently being commercialized by Zink Imaging, Inc. of Bedford, Mass. This printing technology employs a specialized paper that is a multi-layer composite material with embedded color crystals, and a protective polymer overcoat layer. The crystals are colorless before printing and are activated by heat during the printing process to create color. As the paper passes beneath the print head, heat pulses are delivered by an array of heating elements to produce the desired colors at each printed pixel. Further information about this inkless printing technology is provided, for example, in U.S. Pat. No. 7,635,660, the entire disclosure of which is incorporated herein by reference.

In some implementations, the portal service may be configured to track economic conversions associated with the commercial content printed by each printing appliance. For example, if the commercial content is a coupon, redemption of the coupon may be reported to the portal service by the business at which the coupon was redeemed. In some cases, the redeemed coupon may be tied to the consumer by personalizing its content in some way, e.g., printing the user's name or picture on the coupon, using serial numbers, bar codes, or similar technologies, etc. The portal service may also allow (or even require) users to provide additional demographic information about themselves including, for example, preferences of the types of commercial content in which they have an interest, that they dislike or would prefer not to see, and even specific businesses for which they would like to receive commercial content. Incentives (e.g., enhanced commercial offers, additional print consumables, etc.) may be given to encourage users to provide additional personal information, recommend the portal service to friends, etc. This will enable the portal service to develop a rich consumer data set over time.

Commercial entities (represented by network 118 of FIG. 1), e.g., advertisers, content publishers, businesses providing products and services, and the like, can also register and interact with the portal service for the purpose of distributing their commercial content in a targeted way to consumers. Each commercial entity can broadly or precisely specify the target consumer profile to which its commercial content is to be directed, as well as the number of consumers to which the content is distributed (e.g., by specifying how many coupons or offers are to be printed). The commercial entity can then pay for distribution of its commercial content using a number of different approaches such as, for example, payment based on the number of commercial content prints, the number of economic conversion events, etc. The portal service may also be configured to report relevant events to the commercial entity such as, for example, when prints occur, or the performance of the commercial entity's offers in the ecosystem. Such reports could be pushed to the commercial entity as events occur, in batches, or made accessible to the commercial entity in the entity's customized interface on the portal.

Such an approach would be particularly advantageous for small, local, brick-and-mortar businesses in that the barriers to entry are very low, distribution costs can be controlled and are predictable, and the likelihood of economic conversion, e.g., coupon redemption, can be relatively high given the ability to target consumers in the immediate geographic vicinity of each business.

In some implementations, the commercial entity may also be provided with mechanisms for reporting economic conversion events to the portal service, e.g., the redemption of uniquely identified coupons (e.g., coupons having serial numbers, bar codes, etc.). For example, this can be done using any type of computing device by which a connection to the cloud-based portal service can be made including, for example, using a web browser on a personal computer or a smart phone application. Alternatively, the reporting mechanism could be integrated with the merchant's point-of-sale system and could connect with the portal service over the Internet using any of a variety of mechanisms.

According to a particular embodiment, the portal service enables commercial entities to create and publish limited offers, i.e., offers that may be printed only by a limited number of users or only for a limited period of time. In some cases, the commercial entity may publicize the fact that the offers are limited to consumers within the portal service ecosystem. This not only allows the commercial entity to strictly limit the cost of a campaign, but provides incentives for interested users to seek out and take advantage of such offers.

According to embodiments in which the portal service facilitates shipping of print consumables to the user, the portal service has a physical geographic location associated with each printing device, i.e., the address provided by the user to which the print consumables are shipped. According to alternative embodiments, the printing appliance itself can supply its location to the portal service, e.g., using global positioning system technique, the IP address associated with the user's LAN, or any of a wide variety of geo-location techniques. In either case, the knowledge of the user's location may be leveraged to provide the user with highly relevant, geographically targeted commercial content.

According to a specific embodiment, the portal service may be configured to control the ratio of commercial content prints to the user's elective prints, as well as the timing of the respective types of prints. In some implementations, the ratio and/or timing of the commercial content prints may be tied to the user's behavior. For example, the interval between commercial prints or the ratio between commercial and elective prints could be manipulated up and down in relation to the level of the users engagement with the portal service. Thus, the user may be able to influence the type and frequency of commercial content delivered by the printing appliance by engaging in certain kinds of behavior.

One measure of engagement is the number of conversion events associated with the user's commercial prints. That is, for example, a user can be given the incentive of an increased number of elective prints in response to a higher level of coupon redemption. Another measure of engagement might relate to offers or coupons purchased by or affirmatively selected for printing by the user. Yet another measure of engagement might relate to the personal information and preferences provided by the user as discussed above.

Also as mentioned above, free or at least partially subsidized print consumables, e.g., specialized paper, ink cartridges, etc., may be one type of incentive to encourage engagement with the portal service. That is, for example, for an implementation in which the printing appliance requires specially manufactured thermal paper, free paper could be provided to the user in return for particular user behavior, e.g., printing and/or redemption of coupons. However, the user may also be given the option of purchasing the paper if the user is unable or unwilling to engage with the portal service to the degree necessary to satisfy his paper requirements.

According to some implementations, the portal service tracks the print consumable supply at the user's end. For example, where the consumable is a specialized type of paper provided by the portal service, the portal service retains records of paper sent to the user. The portal service can then track how many sheets the user has available for printing by tracking the number of elective and commercial prints by that user's printing appliance. If there are other sources of the consumable, the user may be given the ability in his portal service interface to report purchase of the consumable from such other sources. In any case, because the printing appliance is controlled by the portal service, the portal service can track each and every print by the appliance.

According to some embodiments in which the print consumable is specialized paper, the paper provided by the portal service can be encoded in some way recognizable to the printing appliance, e.g., an embedded watermark or other distinctive marking, so that the portal service can recognize when the user is using paper that he purchased from another source. In addition to being able to track paper usage, such a functionality could be useful where, for example, the user wants to perform a large print job without interruption by commercial prints. That is, where the portal service recognizes that paper from an alternate source is being used, commercial prints could be temporarily halted or made less frequently.

As discussed above, embodiments of the invention contemplate exclusive control of the content delivered to and printed by the printing appliance by the portal service operating in the cloud. Such an approach is particularly advantageous in that it enables an ad-financed model in which the user's elective prints are largely or even entirely subsidized by the delivery of the commercial content. However, it should be understood that embodiments of the invention are contemplated in which some amount of local control and/or delivery of content to the printing appliance may be allowed. That is, while exclusive control of the printing appliance by the portal service is believed to be the best approach with regard to the economic viability of this model, approaches which provide alternative pathways for enabling elective prints by the user are within the scope of the invention.

Another advantage associated with some embodiments is that the unauthorized printing of coupons can be inhibited without requiring sophisticated digital rights management (DRM) software and techniques. For example, to prevent duplicate printing of coupons, some existing coupon services require the user to install DRM software or proprietary device drivers on his machine or network. As will be understood by those of skill in the art, such software or drivers must be designed and managed (on an ongoing basis) for compatibility with different computing devices, operating systems, etc., as well as upgrades thereof. By contrast, because the printing of commercial content in accordance with various embodiments of the invention is controlled by the portal service, such concerns are obviated, i.e., a particular coupon may only be printed as many times as the portal service allows.

It is conceivable that a user could electronically scan the printed coupon and print copies using a different local printer. However, aspects of some embodiments contemplate ways to inhibit or discourage such behavior. For example, embodiments employing specialized paper designed to be used by the printing appliance may reduce the likelihood that coupons could be successfully copied. According to a particular approach, the paper on which the coupons are printed could include some kind of logo or watermark to ensure authenticity, i.e., only coupons having the logo or watermark (as visually verified, for example, by the merchant) would be redeemable. Thus, in embodiments in which the paper is supplied by the portal service and in which the paper is specialized for use with the printing appliance, further obstacles to unauthorized duplication and fraudulent redemption (both by consumers and merchants) may be presented.

According to some embodiments, the portal service may be configured to recognize the commercial content images being distributed by the portal to prevent a user from uploading an image of a previously printed coupon, and then attempting to print the scanned image as an elective print on the specialized paper. This could be done using, for example, digital watermarks, or comparison of the images uploaded by the user (or compressed versions of the images) to the portal service's library of commercial content. This presents yet another way to prevent users from attempting to circumvent the system's limitations on printing commercial content.

In addition, or alternatively, coupons could be uniquely numbered and redemptions tracked to ensure that a particular coupon may only be redeemed once. Such an approach might be preferable for high value coupons, but may be challenging for low value coupons that are subject to high volume distribution. On the other hand, embodiments of the invention actually make such numbering and tracking more feasible than conventional coupon distribution approaches (e.g., newspapers), in which coupons are typically identical in appearance. That is, because of the back end control of the printing appliance, even low value coupons or offers can be personalized or made unique, e.g., by overlaying the user's name or a serial number before or during printing.

According to some implementations, the portal service may provide options to the user for printing additional commercial content beyond the commercial content automatically printed on the user's printing appliance. For example, the portal service may allow the user to browse and select coupons in a variety of categories for which the user might be required to pay a fee, or provide additional information to the portal service. Such options might also include upgrades of commercial content. For example, a coupon might be provided to the user without charge that may be used to take advantage of a 10% discount on a product or service. The portal service might then offer a paid version of a coupon for the same product or service for a greater percentage discount. Such an approach also has a built-in mechanism for tracking a commercial conversion event in that the purchase of the coupon itself may be counted as such an event.

According to a particular class of implementations, the portal service provides an offer queue to allow users to better take advantage of the commercial content made available on the portal. According to implementations in which the user is only allowed to print a limited number of coupons per day (e.g., one per day), the offer queue may be configured to provide a preview of upcoming coupons (e.g., the next week's worth) that each user may prioritize (e.g., reorder) so as to best take advantage of the offers that are the most meaningful to that user. Each day (or other suitable time period), the portal service then prints the offer at the top or front of the user's queue.

The limitations on the printing of commercial content coupled with the user's ability to manage a personal queue of commercial content may result in various benefits. By encouraging each user to choose the offers that have the highest value to that user, the likelihood that the printed offer will lead to the desired economic conversion event is enhanced. In addition, each commercial entity providing offers via the portal service has an incentive to make its offers more attractive to enhance the position of their offers in user queues. That is, information about the way in which users manage their queues can be leveraged by the portal service to provide feedback to commercial entities participating in the ecosystem regarding the performance of their offers. This allows commercial entities to fine tune their offers on the fly without significant financial loss or risk (particularly where the commercial entity is only paying for offers that actually get printed or redeemed). Thus, the net effect should be that users of the system are presented with more and better high value offers over time. This makes it more likely that users will not regard the offers as spam and that they will in fact pay attention to and take advantage of them, thus providing commercial entities higher returns on their investments.

According to some embodiments, users may be enabled to share information about their respective queues with other users, and even to share or trade offers. This may be facilitated within the portal service or within any social networking ecosystem to which a user's queue may be published and/or connected, e.g., Facebook, Twitter, etc. This may be advantageous in that it effectively creates a secondary market for offers that is still managed by the portal service and that is likely to increase the efficiency with which offers lead to conversion events.

According to more specific embodiments, the user may be enabled to both manage his queue and print offers directly from the alternative ecosystem. That is, for example, a user that has published his offer queue on Facebook can reprioritize or reorder his offers within the Facebook ecosystem, and even select an offer for printing which would then be initiated and controlled by the portal service via an external interface to Facebook.

Connection of the portal service to the social networking sites of its users can enable further enhancement and personalization of the services provided to the user. For example, the user may enable the portal service to have access to the user's personal information published on the social networking site that may then be useful to the portal service in determining the types of commercial content that are specifically relevant to that user, e.g., a coupon for a local restaurant might be pushed to a user in anticipation of the birthday of the user's spouse. As will be understood, the possibilities along these lines are virtually limitless.

Offers in a user's queue may also be subject to automatic manipulations by the portal service. For example, if an offer persists in a user's queue for more than some programmable period of time without being printed, the offer may be automatically removed from the queue and/or replaced with new offers. This enables the portal service to periodically refresh a user's queue, again increasing the likelihood of conversion events. As will be understood, any of a variety of automatic queue management or refresh algorithms from a variety of computing contexts (e.g., cache memory management techniques) may be employed to remove and/or replace offers in users' offer queues.

Embodiments are also contemplated in which the daily limitation on printing commercial content may apply to particular classes of content with other classes of commercial content being available for selection and printing on less restrictive bases including, for example, unlimited classes that the user may print and redeem at any time. According to such embodiments, a user may be able to search or browse a catalog of commercial content available on the portal service.

As should be apparent from the foregoing description, embodiments of the invention may be characterized by significant advantages. For example, the likelihood that the printing of commercial content will lead to conversion events (e.g., redemption of coupons) may be enhanced by various aspects of such embodiments such as, for example, the highly targeted manner in which commercial content is distributed, user self selection, convenience and ease-of-use of the printing appliance, etc. In another example, commercial entities may participate in the ecosystem and run effective, targeted campaigns which require very little lead time and only minor up front commitment of financial resources, as well as the ability to modify and/or redirect campaigns on the fly without substantial additional cost. In yet another example, some embodiments enable an advertising-financed print service which not only provides a valuable service to consumers (e.g., free photo printing), but does so in a way that provides further benefits to both the consumers (e.g., relevant commercial offers) and businesses (e.g., efficient marketing channels). These are but a few of the variety of advantages by which various embodiments may be characterized.

While the invention has been particularly shown and described with reference to specific embodiments thereof, it will be understood by those skilled in the art that changes in the form and details of the disclosed embodiments may be made without departing from the spirit or scope of the invention. For example, it is contemplated that a particular implementation of the portal service employs a Rights-Over-IP (ROIP) ecosystem in which commercial content (e.g., coupons and offers) is implemented using digital objects that represent one or more rights, also known as digital bearer instruments. According to such an implementation, external interfaces to the ecosystem, e.g., to payment systems, third-party web sites, etc., may also be implemented in accordance with ROIP technology. Examples of ROIP technology which may be suitable for use with such an implementation are described in U.S. Pat. No. 7,707,066, No. 7,707,121, and No. 7,814,025, and U.S. Patent Publications No. US-2005/0273805, No. US-2007/0162300, No. US-2007/0286393, No. US-2007/0286076, No. US-2007/0157320, No. US-2008/0205850, and No. US-2008/0243693, the entire disclosure of each of which is incorporated herein by reference in its entirety for all purposes. It should be noted, however, that ROIP technology is not required to implement embodiments of the present invention, and that any of a wide variety of computing paradigms may be employed without departing from the scope of the invention.

In addition, the computer program instructions with which embodiments of the invention and their various aspects and functionalities are implemented may be implemented using any of a variety of programming languages, stored in any type of non-transient, computer-readable storage media, and may be executed according to a variety of computing models including, but not limited to, a client/server model, a peer-to-peer model, on a stand-alone computing device, or according to a distributed computing model in which various of the functionalities described herein may be effected or employed at different locations.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for operating a printing appliance connected to a network, comprising:
establishing a first connection to a computing device operating on the network;
establishing a second connection to the printing appliance over the network;
in response to identification of elective content by the computing device via the first connection, transmitting the elective content to the printing appliance via the second connection, and controlling printing of the elective content by the printing appliance via the second connection without intervention by the computing device; and
selecting commercial content without intervention by the computing device, transmitting the commercial content to the printing appliance via the second connection, and controlling printing of the commercial content by the printing appliance via the second connection without intervention by the computing device.

2. The method of claim 1 wherein the commercial content comprises one or more of coupons, offers, or advertisements.

3. The method of claim 1 further comprising enabling selection of additional commercial content via the first connection, transmitting the additional commercial content to the printing appliance via the second connection, and controlling printing of the additional commercial content by the printing appliance via the second connection without intervention by the computing device.

4. The method of claim 1 further comprising, where one or more criteria relating to the printed commercial content is met, sending print consumables to an address associated with the printing appliance, wherein the print consumables are required for operation of the printing appliance, and wherein the print consumables are economically subsidized in relation to meeting of the one or more criteria.

5. The method of claim 4 wherein the print consumables comprise one or more of paper, thermal paper, ink cartridges, or toner.

6. The method of claim 1 wherein the printing appliance comprises a printing subsystem that employs an inkless printing technology to print the elective and commercial content on specialized paper that comprises a multi-layer composite material with embedded color crystals configured to be activated by heat from the printing subsystem.

7. The method of claim 1 further comprising:
providing an interface by which a user may gain restricted access to commercial offers corresponding to a portion of the commercial content, the restricted access limiting the user to taking advantage of only a specified number of the commercial offers during each of a plurality of consecutive time periods;
enabling the user to prioritize a first subset of the commercial offers for a first number of the consecutive time periods, thereby reordering the first subset of the commercial offers relative to the first number of the consecutive time periods; and
enabling the user to take advantage of the specified number of the first subset of commercial offers during each of the first number of consecutive time periods in accordance with the reordering of the first subset of the commercial offers.

8. The method of claim 1 further comprising enabling a commercial entity to provide a portion of the commercial content and to specify one or more parameters relating to a campaign of which the portion of the commercial content is a part.

9. The method of claim 8 wherein the one or more parameters relating to the campaign include one or more of a geographic area, a target consumer profile, a number of commercial prints, or offer details.

10. The method of claim 1 further comprising receiving the elective content from the computing device via the first connection.

11. The method of claim 1 further comprising determining a ratio of the commercial content to the elective content with reference to user engagement with a portal service that controls printing of the elective content and the commercial content on the printing appliance.

12. The method of claim 1 wherein the network comprises any combination of a wide area network, a local area network, a mobile data network, a wireless network, an Ethernet network, a telecommunications network, a cable network, or a satellite network.

13. A computer-implemented method for using a printing appliance on a network, comprising:
establishing a first connection between a computing device operating on the network and a remote portal service over the network;
establishing a second connection between the printing appliance and the remote portal service over the network;
identifying elective content to the remote portal service via the first connection, receiving the elective content at the printing appliance via the second connection, and printing the elective content with the printing appliance under control of the remote portal service via the second connection without intervention by the computing device; and
receiving commercial content at the printing appliance via the second connection without intervention by the computing device, and printing the commercial content with the printing appliance under control of the remote portal service via the second connection without intervention by the computing device.

14. The method of claim 13 wherein the commercial content comprises one or more of coupons, offers, or advertisements.

15. The method of claim 13 further comprising identifying additional commercial content to the remote portal service via the first connection, receiving the additional commercial content at the printing appliance via the second connection, and printing the additional commercial content with the printing appliance under control of the remote portal service via the second connection without intervention by the computing device.

16. The method of claim 13 further comprising, where one or more criteria relating to the printed commercial content is met, receiving print consumables at an address associated with the printing appliance, wherein the print consumables are required for operation of the printing appliance, and wherein the print consumables are economically subsidized in relation to meeting of the one or more criteria.

17. The method of claim 16 wherein the print consumables comprise one or more of paper, thermal paper, ink cartridges, or toner.

18. The method of claim 13 wherein the printing appliance comprises a printing subsystem that employs an inkless printing technology to print the elective and commercial content on specialized paper that comprises a multi-layer composite material with embedded color crystals configured to be activated by heat from the printing subsystem.

19. The method of claim 13 further comprising:
presenting an interface by which a user may gain restricted access to commercial offers corresponding to a portion of the commercial content, the restricted access limiting the user to taking advantage of only a specified number of the commercial offers during each of a plurality of consecutive time periods;
prioritizing a first subset of the commercial offers for a first number of the consecutive time periods, thereby reordering the first subset of the commercial offers relative to the first number of the consecutive time periods; and
taking advantage of the specified number of the first subset of commercial offers during each of the first number of consecutive time periods in accordance with the reordering of the first subset of the commercial offers.

20. The method of claim 13 further comprising transmitting the elective content from the computing device to the remote portal service via the first connection.

21. The method of claim 13 further comprising engaging with the remote portal service thereby affecting a ratio of the commercial content to the elective content printed by the printing appliance.

22. The method of claim 13 wherein the network comprises any combination of a wide area network, a local area network, a mobile data network, a wireless network, an Ethernet network, a telecommunications network, a cable network, or a satellite network.

23. A computer-implemented method for operating a printing appliance connected to a network, comprising:
establishing a first connection over the network to a third-party web site to which a computing device operating on the network is also connected;
establishing a second connection to the printing appliance over the network;
receiving elective content via the first connection in response to identification of the elective content on the third-party web site by the computing device, transmitting the elective content to the printing appliance via the second connection, and controlling printing of the elective content by the printing appliance via the second connection without intervention by the computing device; and
selecting commercial content without intervention by the computing device, transmitting the commercial content to the printing appliance via the second connection, and controlling printing of the commercial content by the printing appliance via the second connection without intervention by the computing device.

24. The method of claim 23 wherein the third-party web site comprises a social networking web site.

25. The method of claim 23 wherein the commercial content comprises one or more of coupons, offers, or advertisements.

26. The method of claim 23 further comprising enabling selection of additional commercial content via a third connection to the computing device, transmitting the additional commercial content to the printing appliance via the second connection, and controlling printing of the additional commercial content by the printing appliance via the second connection without intervention by the computing device.

27. The method of claim 23 further comprising, where one or more criteria relating to the printed commercial content is met, sending print consumables to an address associated with the printing appliance, wherein the print consumables are required for operation of the printing appliance, and wherein the print consumables are economically subsidized in relation to meeting of the one or more criteria.

28. The method of claim 27 wherein the print consumables comprise one or more of paper, thermal paper, ink cartridges, or toner.

29. The method of claim 23 wherein the printing appliance comprises a printing subsystem that employs an inkless printing technology to print the elective and commercial content on specialized paper that comprises a multi-layer composite material with embedded color crystals configured to be activated by heat from the printing subsystem.

30. The method of claim 23 further comprising:
providing an interface by which a user may gain restricted access to commercial offers corresponding to a portion of the commercial content, the restricted access limiting the user to taking advantage of only a specified number of the commercial offers during each of a plurality of consecutive time periods;
enabling the user to prioritize a first subset of the commercial offers for a first number of the consecutive time periods, thereby reordering the first subset of the commercial offers relative to the first number of the consecutive time periods; and
enabling the user to take advantage of the specified number of the first subset of commercial offers during each of the first number of consecutive time periods in accordance with the reordering of the first subset of the commercial offers.

31. The method of claim 23 further comprising enabling a commercial entity to provide a portion of the commercial content and to specify one or more parameters relating to a campaign of which the portion of the commercial content is a part.

32. The method of claim 31 wherein the one or more parameters relating to the campaign include one or more of a geographic area, a target consumer profile, a number of commercial prints, or offer details.

33. The method of claim 23 further comprising determining a ratio of the commercial content to the elective content with reference to user engagement with a portal service that controls printing of the elective content and the commercial content on the printing appliance.

34. The method of claim 23 wherein the network comprises any combination of a wide area network, a local area network, a mobile data network, a wireless network, an Ethernet network, a telecommunications network, a cable network, or a satellite network.

35. A computer-implemented method for using a printing appliance on a network, comprising:
authorizing a first connection over the network between a remote portal service and a third-party web site to which a computing device operating on the network is also connected;
establishing a second connection between the printing appliance and the remote portal service over the network;
identifying elective content on the third-party web site for transmission to the remote portal service via the first connection, receiving the elective content at the printing appliance via the second connection, and printing the elective content with the printing appliance under control of the remote portal service via the second connection without intervention by the computing device; and
receiving commercial content at the printing appliance via the second connection without intervention by the computing device, and printing the commercial content with the printing appliance under control of the remote portal service via the second connection without intervention by the computing device.

36. The method of claim 35 wherein the third-party web site comprises a social networking web site.

37. The method of claim 35 wherein the commercial content comprises one or more of coupons, offers, or advertisements.

38. The method of claim 35 further comprising identifying additional commercial content to the remote portal service via a third connection, receiving the additional commercial content at the printing appliance via the second connection, and printing the additional commercial content with the printing appliance under control of the remote portal service via the second connection without intervention by the computing device.

39. The method of claim 35 further comprising, where one or more criteria relating to the printed commercial content is met, receiving print consumables at an address associated with the printing appliance, wherein the print consumables are required for operation of the printing appliance, and wherein the print consumables are economically subsidized in relation to meeting of the one or more criteria.

40. The method of claim 39 wherein the print consumables comprise one or more of paper, thermal paper, ink cartridges, or toner.

41. The method of claim 35 wherein the printing appliance comprises a printing subsystem that employs an inkless printing technology to print the elective and commercial content on specialized paper that comprises a multi-layer composite material with embedded color crystals configured to be activated by heat from the printing subsystem.

42. The method of claim 35 further comprising:
presenting an interface by which a user may gain restricted access to commercial offers corresponding to a portion of the commercial content, the restricted access limiting the user to taking advantage of only a specified number of the commercial offers during each of a plurality of consecutive time periods;
prioritizing a first subset of the commercial offers for a first number of the consecutive time periods, thereby reordering the first subset of the commercial offers relative to the first number of the consecutive time periods; and
taking advantage of the specified number of the first subset of commercial offers during each of the first number of consecutive time periods in accordance with the reordering of the first subset of the commercial offers.

43. The method of claim 35 further comprising engaging with the remote portal service thereby affecting a ratio of the commercial content to the elective content printed by the printing appliance.

44. The method of claim 35 wherein the network comprises any combination of a wide area network, a local area network, a mobile data network, a wireless network, an Ethernet network, a telecommunications network, a cable network, or a satellite network.

45. A computer-implemented method for supporting a printing appliance connected to a network, comprising:
establishing a first connection to the printing appliance over the network;
tracking printing by the printing appliance of commercial content via the first connection; and
where one or more criteria relating to the printed commercial content is met, sending print consumables to an address associated with the printing appliance, wherein the print consumables are required for operation of the printing appliance, and wherein the print consumables are economically subsidized in relation to meeting of the one or more criteria.

46. The method of claim 45 wherein the commercial content comprises one or more of coupons, offers, or advertisements.

47. The method of claim 45 wherein the print consumables comprise one or more of paper, thermal paper, ink cartridges, or toner.

48. The method of claim 45 wherein the printing appliance comprises a printing subsystem that employs an inkless printing technology to print the elective and commercial content on specialized paper that comprises a multi-layer composite material with embedded color crystals configured to be activated by heat from the printing subsystem, and wherein the print consumables comprises the specialized paper.

49. The method of claim 45 further comprising selecting the commercial content, transmitting the commercial content to the printing appliance via the first connection, and exclusively controlling printing of the commercial content by the printing appliance via the first connection.

50. The method of claim 49 further comprising determining a ratio of the commercial content to elective content with reference to user engagement with a portal service that controls printing of the elective content and the commercial content on the printing appliance.

51. A printing appliance for use on a network, comprising:
a printing subsystem configured to print content on a print medium;
a configuration interface configured to facilitate connection of the printing appliance to the network;
processing resources configured to control operation of the printing appliance; and
a network interface configured to connect to the network and to enable communication between the processing resources and a remote portal service via a connection over the network;
wherein the processing resources are further configured to only allow printing of the content by the printing subsystem under control of the remote portal service via the connection.

52. The printing appliance of claim 51 wherein the printing subsystem employs an inkless printing technology to print the content, and the print medium comprises specialized paper that comprises a multi-layer composite material with embedded color crystals configured to be activated by heat from the printing subsystem.

53. The printing appliance of claim 51 wherein the network interface is configured to connect to the network that comprises any combination of a wide area network, a local area network, a mobile data network, a wireless network, an Ethernet network, a telecommunications network, a cable network, or a satellite network.

54. A computer-implemented method for managing commercial offers, comprising:
providing an interface in a computing device by which a user may gain restricted access to the commercial offers, the restricted access limiting the user to taking advantage of only a specified number of the commercial offers during each of a plurality of consecutive time periods;
enabling the user in the interface to prioritize a first subset of the commercial offers for a first number of the consecutive time periods, thereby reordering the first subset of the commercial offers relative to the first number of the consecutive time periods; and
enabling the user to take advantage of the specified number of the first subset of commercial offers during each of the first number of consecutive time periods in accordance with the reordering of the first subset of the commercial offers.

55. The method of claim 54 wherein the specified number of the commercial offers is one, and wherein the consecutive time periods comprise one of days, weeks, months, or years.

56. The method of claim 54 wherein the commercial offers comprise one or more of coupons, offers, or advertisements.

57. The method of claim 54 wherein the commercial offers are made available in a computing ecosystem that includes a plurality of other users, the method further comprising enabling the user to transfer rights to one or more of the first subset of the commercial offers to one or more of the other users.

58. The method of claim 54 further comprising enabling the user to publish the first subset of the commercial offers on a third-party web site, and to share at least some of the first subset of the commercial offers with other users on the third-party web site.

59. The method of claim 58 wherein the third-party web site comprises a social networking web site.
